(19) United States
(12) Patent Application Publication
(10) Pub. No.: US 2020/0198116 A1
(43) Pub. Date: Jun. 25, 2020

(54) BATTERY OPERATED HYDRAULIC CUTTING AND CRIMPING TOOLS AND METHOD

(71) Applicant: Huskie Tools, Inc., Glendale Heights, IL (US)

(72) Inventor: Nicholas Skrobot, Glendale Heights, IL (US)

(21) Appl. No.: 16/721,390

(22) Filed: Dec. 19, 2019

Related U.S. Application Data
(63) Continuation of application No. PCT/US2019/067466, filed on Dec. 19, 2019.
(60) Provisional application No. 62/781,705, filed on Dec. 19, 2018.

(51) Int. Cl. B25F 5/02; B33Y 80/00; B23D 29/00; B25B 28/00; B25F 5/00; H01R 43/042

(52) U.S. Cl. CPC B25F 5/02; B33Y 80/00; H01R 43/0428; B25B 28/00; B25F 5/005; B23D 29/002

(57) ABSTRACT

Light weight hydraulic cutting and crimping tools built with advanced composite materials, engineering plastics and additive manufacturing, replace current steel and aluminum components and traditional subtractive manufacturing.

### CROSS-REFERENCE TO RELATED APPLICATIONS

This application is a non-provisional application claiming priority to U.S. Provisional Application No. 62/781,705, filed Dec. 19, 2018, and is also a Continuation of International Application No. PCT/US19/67466 filed on Dec. 19, 2019 the entire contents of each is hereby incorporated by reference in the entirety.

### TECHNICAL FIELD AND BACKGROUND OF THE INVENTION

The present invention relates to the field of cable cutting, and compression (or crimping) of connectors in the electrical industry, particularly to the hydraulic tools used by utility linemen and professional electricians to cut electrically conductive cable and to install connectors. The present invention includes a series of cutting and compression tools made from light-weight, non-metallic and metallic materials, that results in tools that are lighter weight and ergonomically improved as compared to existing cutting and compression tools.

Handheld cutting and compression tools are used by utility linemen and professional electricians. Manual or battery powered tools use hydraulic and/or mechanical means to produce cutting or crimping forces sufficient to cut cable or deform connectors. Tools are designed to work with the high forces and made from steel and aluminum components. These materials have excellent strength and stiffness properties, however are also highly dense and result in tools that are heavy and ergonomically challenging to carry and operate.

### BRIEF SUMMARY OF THE INVENTION

It is therefore an object of this present invention to provide cutting and compression tools that are lighter weight and more ergonomic through improved design and construction utilizing both metallic and non-metallic advanced materials.

According to an aspect of the invention, a battery powered hydraulic cutting tool may include a cutting assembly made from a material with high specific strength, a ram assembly made from titanium, and be constructed using additive manufacturing techniques.

According to another embodiment of the invention, the cutting assembly may include a body head, a blade, a latch, a main head, a spacer, a head sheer, a ram, and a body.

According to another embodiment of the invention, the material with high specific strength is one or more of: carbon fiber composite material, thermoplastic or thermoset polymer materials or resin systems reinforced with continuous carbon fiber, chopped fiber or glass fiber, or titanium.

According to another embodiment of the invention, the ram assembly may include a pin, a bolt, a spring, a washer, a nut, and a blade screw.

According to another embodiment of the invention, the additive manufacturing techniques may include 3D printing or the like. Such additive manufacturing techniques may be combined with one or more conventional techniques such as molding, or bonding, which may include lamination of metal and composite material with epoxy, or other conventional processes.

According to another embodiment of the invention, the cutting assembly may include a body, a ram, a body head, a support plate, a link, a link head, a collar, a blade assembly, and a blade.

According to another embodiment of the invention, the cutting assembly may include a body, a ram, a body head, a support plate, a link, a link head, a collar, a blade assembly, and a blade.

According to another embodiment of the invention, the ram assembly may include a spring, a shoulder bolt, a pin, and a stud bolt.

According to another aspect of the invention, a battery powered hydraulic compression tool may include a ram assembly made from a material with high specific strength, a ram assembly made from titanium, and be constructed using additive manufacturing techniques.

According to another embodiment of the invention, the ram assembly may include a head, a body, a ram, a ram head, and a guide ring.

According to another embodiment of the invention, the ram assembly may include a spring.

According to another embodiment of the invention, the ram assembly may include a body, a ram, a body head, a die holder, a yoke, and a latch.

According to another embodiment of the invention, the ram assembly may include a spring and a slide pin.

According to another embodiment of the invention, wherein the ram assembly may include a body, a ram, a cylinder head, a tool jaw, a yoke, and a grip.

According to another embodiment of the invention, the ram assembly may include a spring, a lock pin, and a pin.

According to embodiments of the invention, a method for manufacturing a battery powered hydraulic cutting or compression tool includes using at least one additive manufacturing technique to create a first set of components; using at least one conventional manufacturing technique to create a second set of components; and building the tool by combining at least a portion of the first set of components and at least a portion of the second set of components.

### BRIEF DESCRIPTION OF THE DRAWINGS

Features, aspects and advantages of the present invention are understood when the following detailed description of the invention is read with reference to the accompanying drawings, in which:

FIG. 1 is a photograph showing an embodiment of the invention;

FIG. 2A is a photograph showing a cutting tool embodiment of the invention;

FIGS. 2B, 2C, 2D, and 2E together show an exploded view of the embodiment of the invention shown in FIG. 2A;

FIG. 3A is a photograph showing a cutting tool embodiment of the invention;

FIGS. 3B, 3C, 3D, and 3E together show an exploded view of the embodiment shown in FIG. 3A;

FIG. 4A is a photograph showing a cutting tool embodiment of the invention;

FIGS. 4B, 4C, and 4D together show an exploded view of the embodiment shown in FIG. 4A;

FIG. 5A is a photograph showing a compression tool embodiment of the invention;

FIGS. 5B, 5C, and 5D together show an exploded view of the embodiment shown in FIG. 5A;

FIG. 6A is a photograph showing a compression tool embodiment of the invention;

FIGS. 6B, 6C, and 6D together show an exploded view of the embodiment shown in FIG. 6A;

FIG. 7A is a photograph showing a compression embodiment of the invention;

FIGS. 7B, 7C, and 7D together show an exploded view of the embodiment shown in FIG. 7A;

FIG. 8 is a photograph of a manually operated tool embodiment of the invention;

FIG. 9 is a photograph of a remotely powered embodiment of the invention; and

FIG. 10 is a flowchart illustrating a method for manufacturing a battery powered hydraulic cutting or compression tool according to embodiments of the invention.

### DETAILED DESCRIPTION OF THE INVENTION

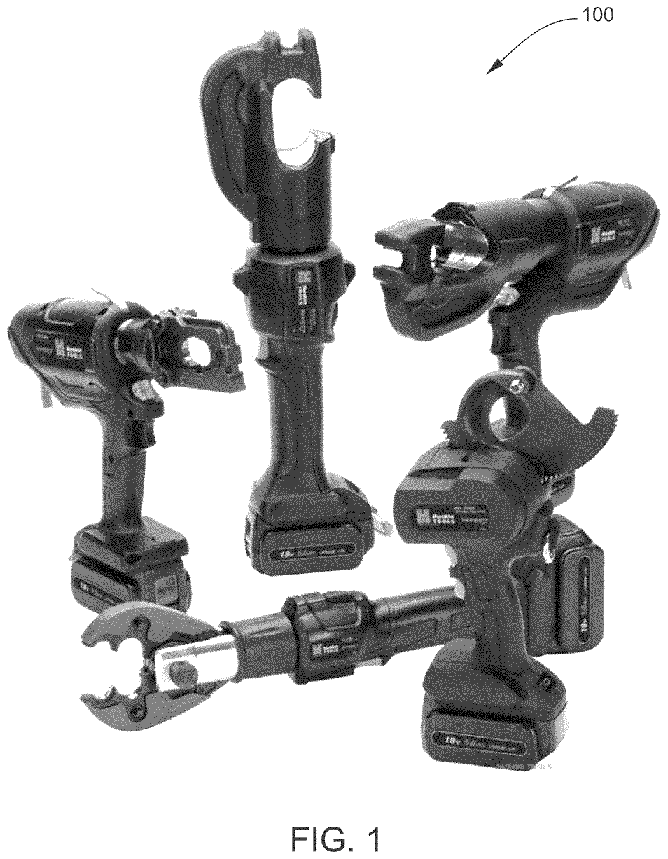

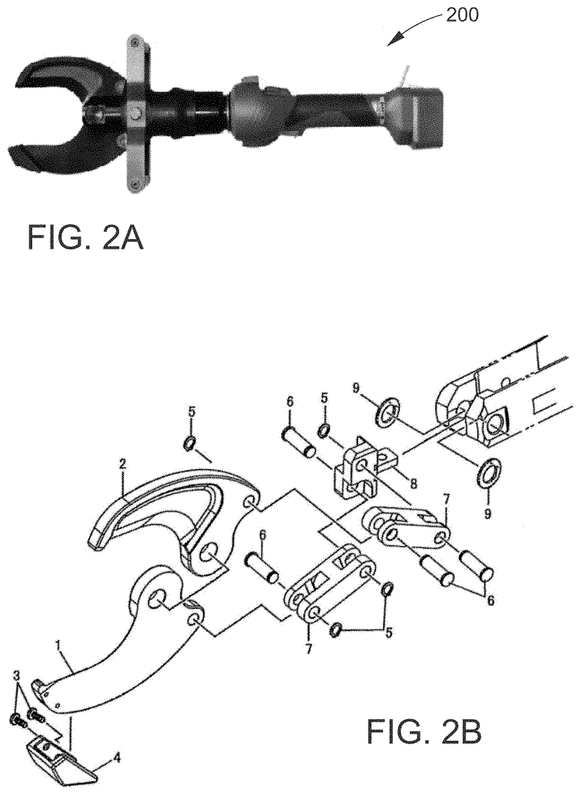

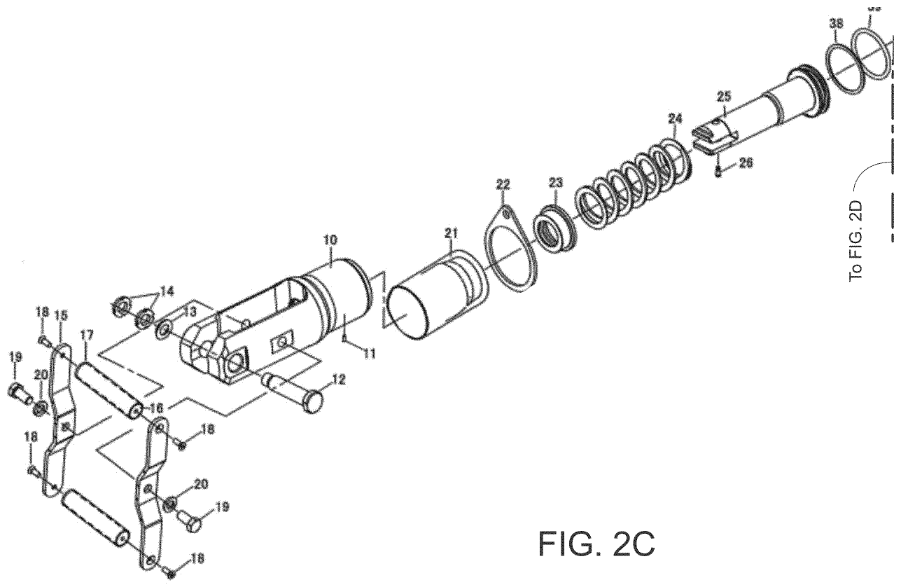

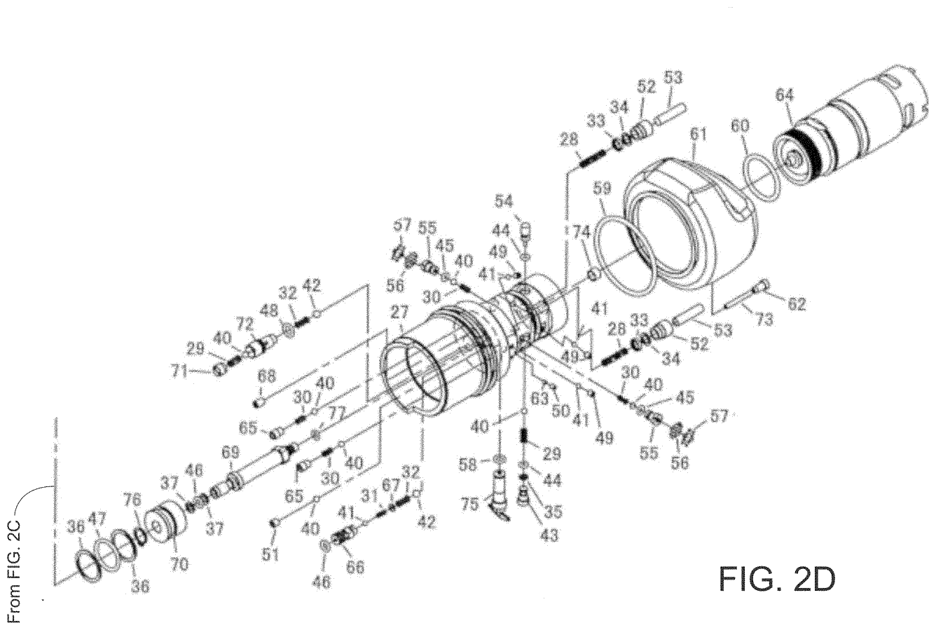

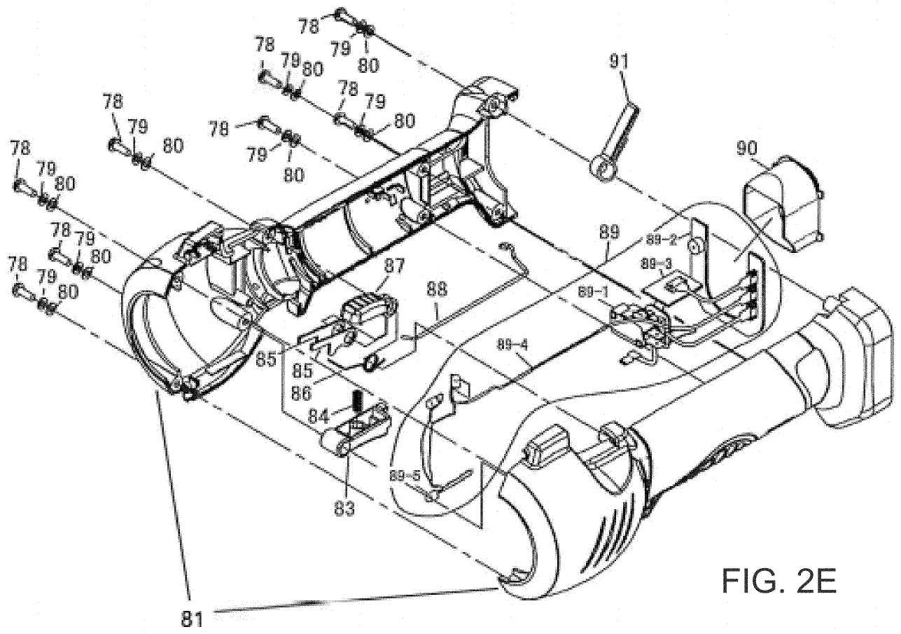

Referring to FIG. 1, a group 100 of cutting and compression tools are shown. Generally, the tools are lightweight hydraulic cutting and crimping tools built with advanced composite materials, engineering plastics, and additive manufacturing which replaces prior art steel and aluminum components and subtractive manufacturing. FIGS. 2A, 2B, 2C, 2D, and 2E illustrates a cutting tool according to embodiments of the invention. FIG. 2B, various components 1, 2, 6, 7, 8, would, according to the prior art, be made of metal. Likewise, according to the prior art, various components 10, 11, 12, 15, 16, 17, 19, 21, 22, 23, and 25 shown in FIG. 2C would be made of metal. Further, components 27, 36, 37, 46, 47, 69, 70, and 76 shown in FIG. 2D would, according to the prior art, be made of metal. According to embodiments of the present invention, however, the components noted above are made from metal composite, high performance polymers, carbon fiber composite materials, ceramics, and/or ceramic and metal composites, and/or titanium.

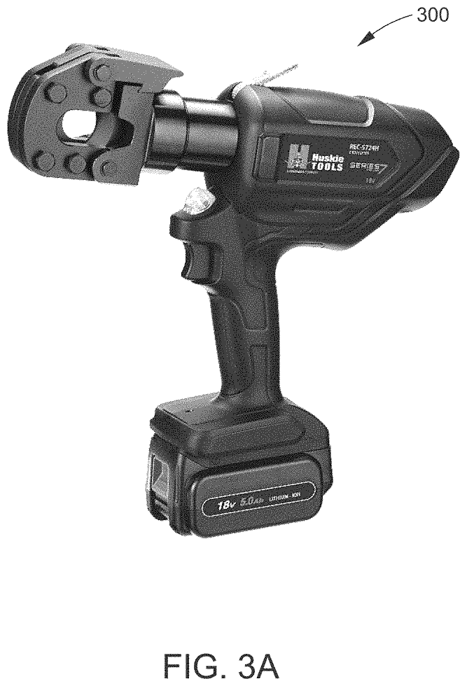

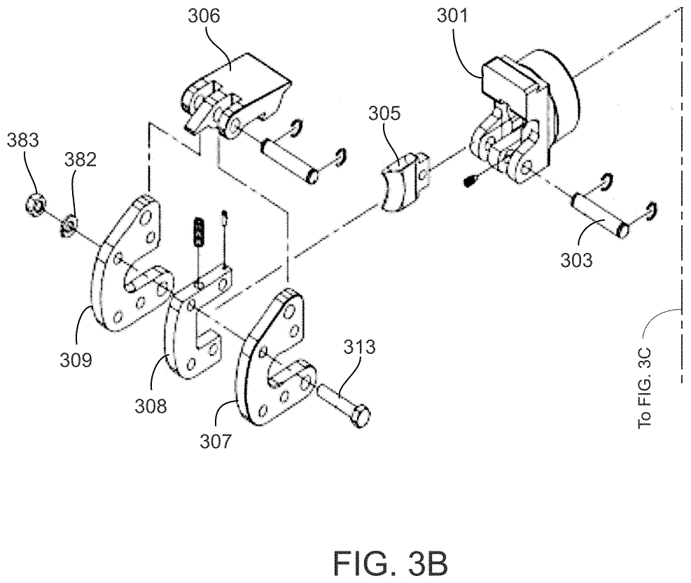

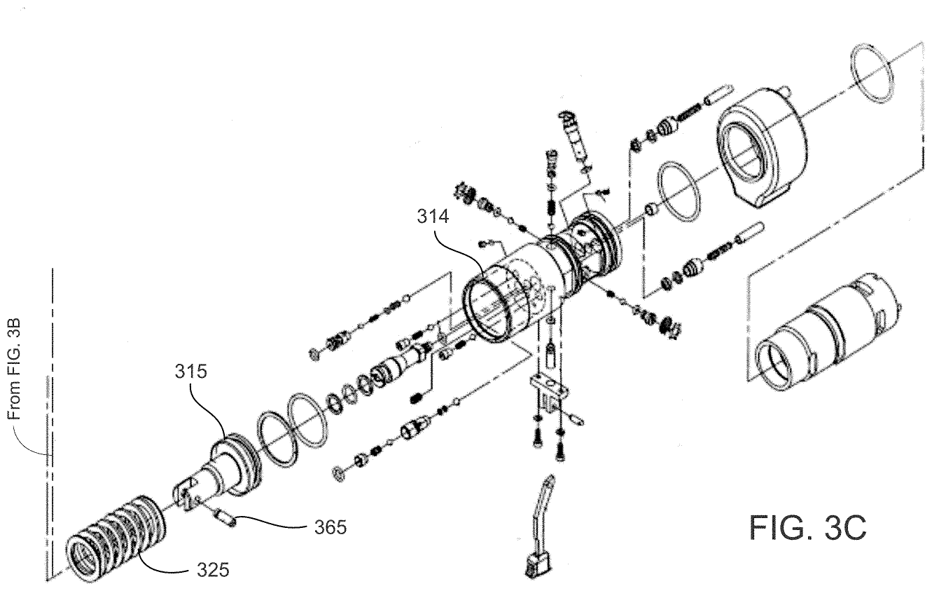

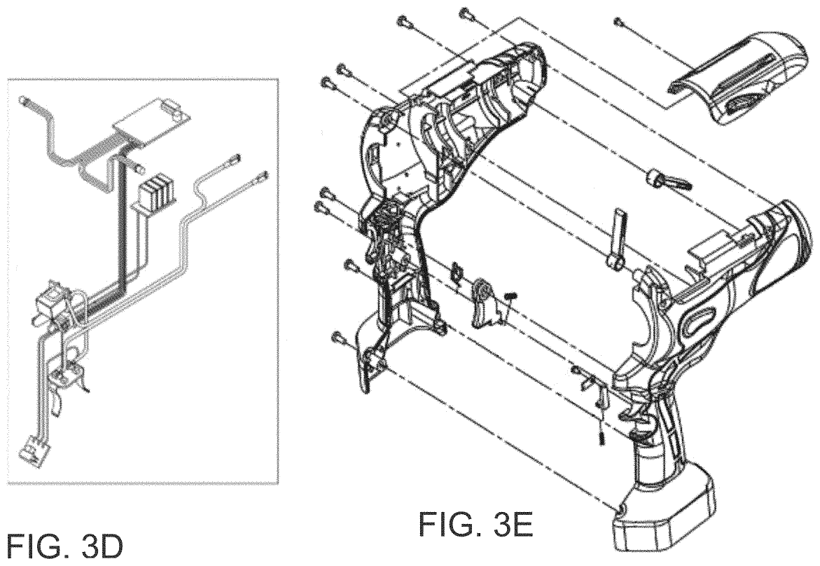

Referring now to FIGS. 3A, 3B, 3C, 3D, and 3E, a cutting tool 300 is shown. The body head 301, blade 305, latch 306, main head 307, spacer 308, head sheer 309, ram 315, and body 314 may be designed and made from advanced materials with high specific strength, such as carbon fiber composite material, thermoplastic or thermoset polymer materials or resin systems reinforced with continuous carbon fiber, chopped fiber or glass fiber, or titanium. Alternatively, one or more may be of a metal composite construction, so to provide surfaces with the strength and hardness properties of tool steel supported with the strength and weight properties of high performance polymers.

Still referring to FIGS. 3A, 3B, 3C, 3D, and 3E, pin 303, bolt 313, spring 325, washer 382, nut 383, and blade screw 365 may be designed and made from titanium or a titanium alloy. According to the embodiment shown in FIGS. 3A, 3B, 3C, 3D, and 3E, components may be constructed using additive manufacturing techniques, which may include 3D printing or the like. Such additive manufacturing techniques may be combined with one or more conventional techniques such as molding, or bonding, which may include lamination of metal and composite material with epoxy, or other conventional processes.

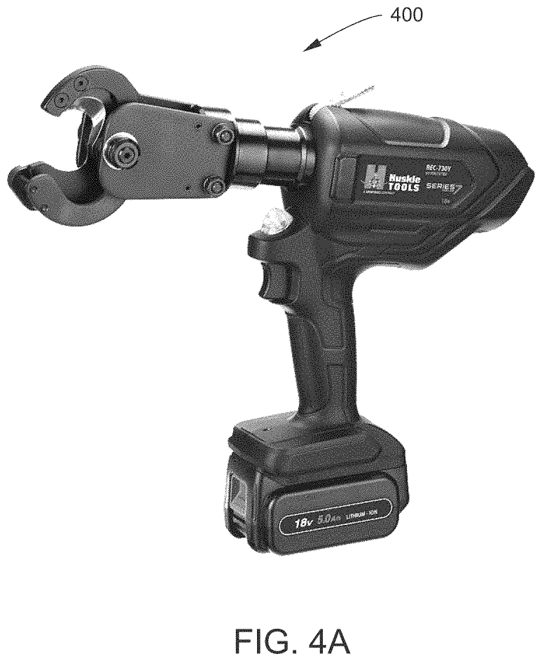

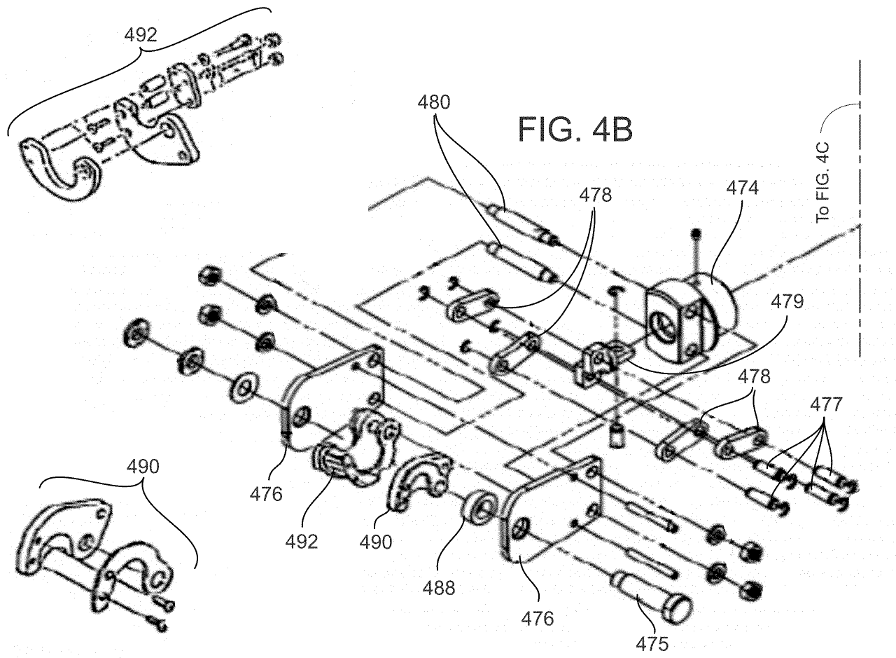

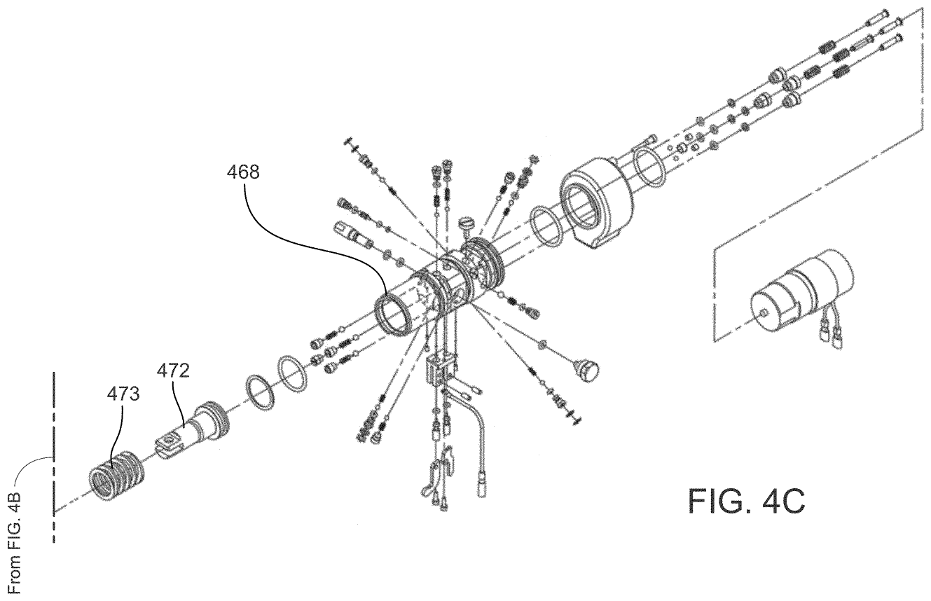

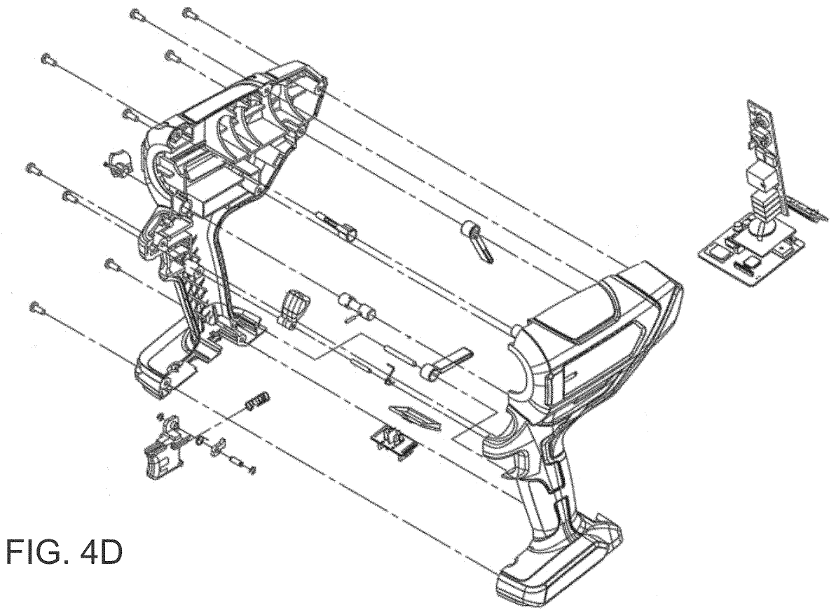

Referring now to FIGS. 4A, 4B, 4C, and 4D, a cutting tool 400 is shown. A body 468, ram 472, body head 474, support plate 476, link 478, link head 479, collar 488, blade assembly 490, and blade 492 may be designed and made from advanced materials with high specific strength, such as carbon fiber composite material, thermoplastic or thermoset polymer materials or resin systems reinforced with continuous carbon fiber, chopped fiber or glass fiber, or titanium. Alternatively, they may be of a metal composite construction, so to provide surfaces with the strength and hardness properties of tool steel supported with the strength and weight properties of high performance polymers.

Also referring to the embodiment shown in FIGS. 4A, 4B, 4C, and 4D, spring 473, shoulder bolt 475, pin 477, and stud bolt 480 may be designed and made from titanium or a titanium alloy.

According to the embodiment shown in FIGS. 4A, 4B, 4C, and 4D components may be constructed using additive manufacturing techniques such as 3D printing or the like. Such additive manufacturing techniques may be combined with one or more conventional techniques such as molding, or bonding, which may include lamination of metal and composite material with epoxy, or other conventional processes.

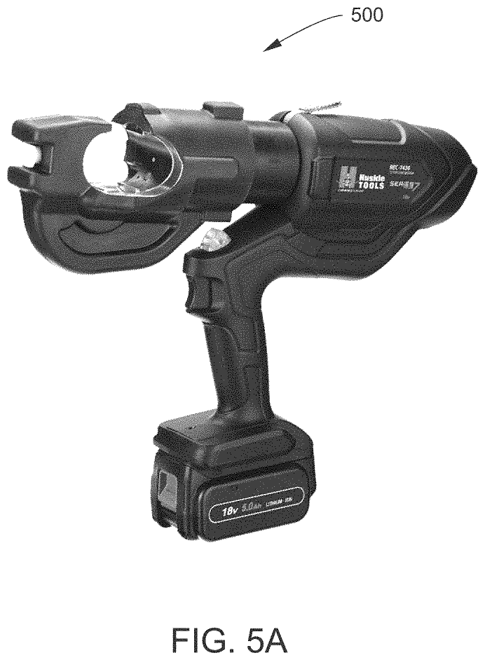

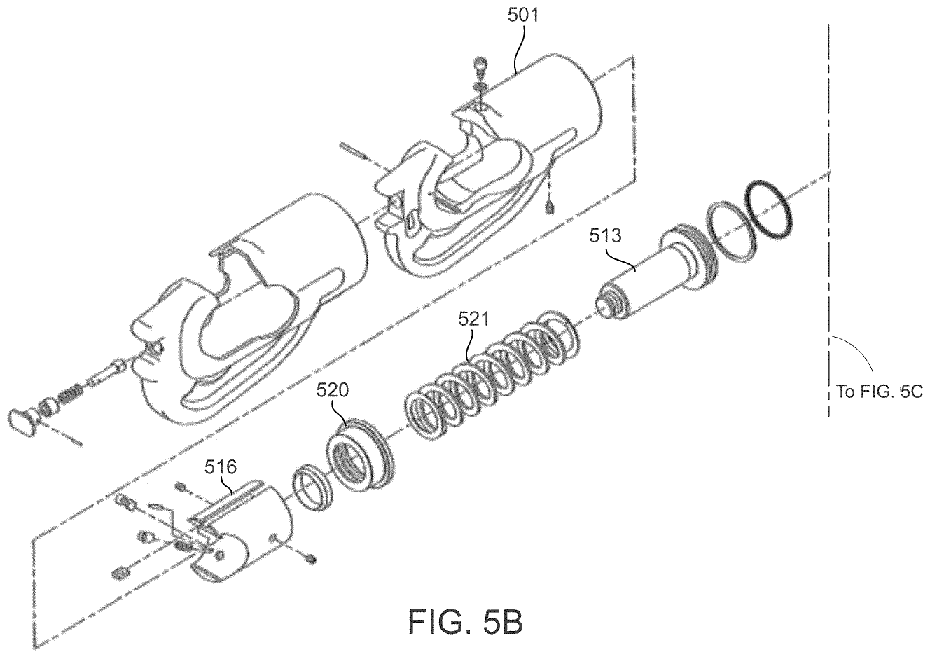

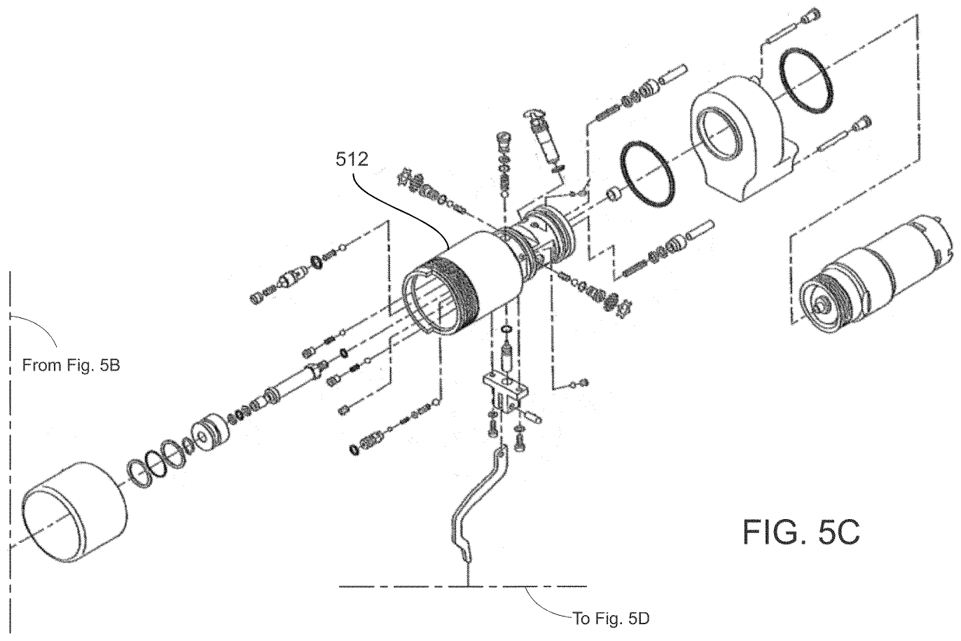

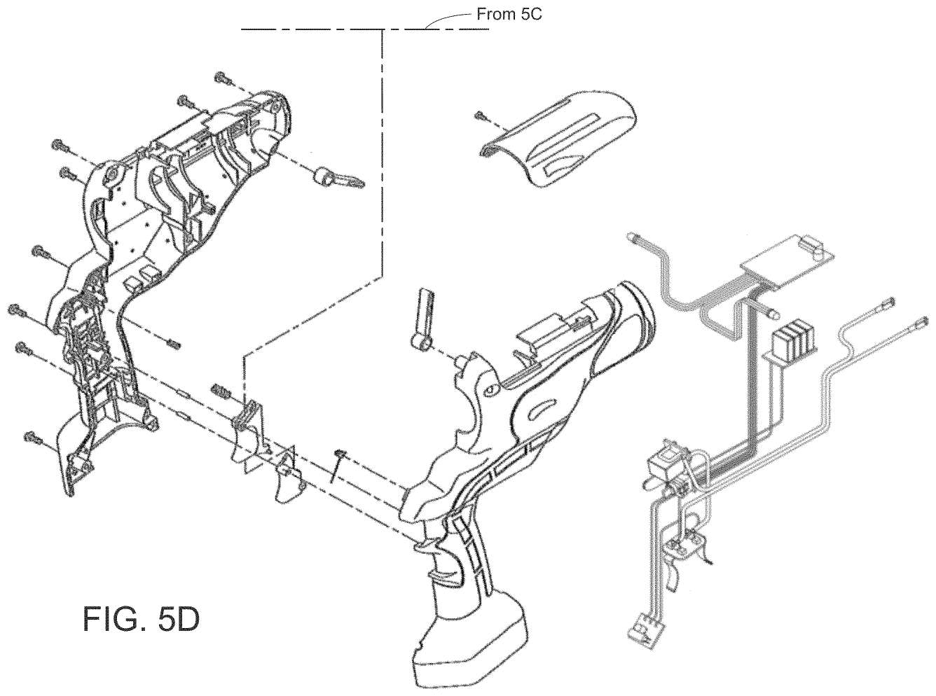

Referring now to FIGS. 5A, 5B, 5C, and 5D, a compression tool is shown according to embodiments of the invention. The head 501, body 512, ram 513, ram head 516, and guide ring 520 may be designed and made from advanced materials with high specific strength, such as carbon fiber composite material, thermoplastic or thermoset polymer materials or resin systems reinforced with continuous carbon fiber, chopped fiber or glass fiber, or titanium. Alternatively they may be of a metal composite construction, so to provide surfaces with the strength and hardness properties of tool steel supported with the strength and weight properties of high performance polymers.

Referring to FIGS. 5A, 5B, 5C, and 5D, spring 521 may be designed and made from titanium or a titanium alloy. Likewise, components may be constructed using additive manufacturing techniques that may include 3D printing or the like. Such additive manufacturing techniques may be combined with one or more conventional techniques such as molding, or bonding, which may include lamination of metal and composite material with epoxy, or other conventional processes.

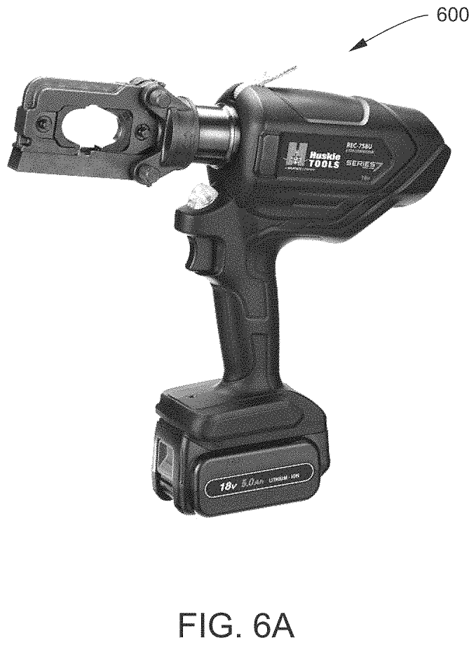

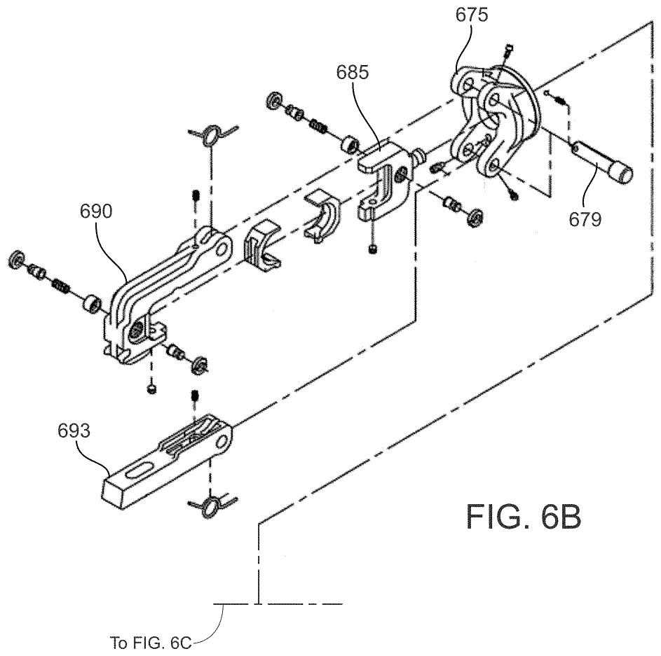

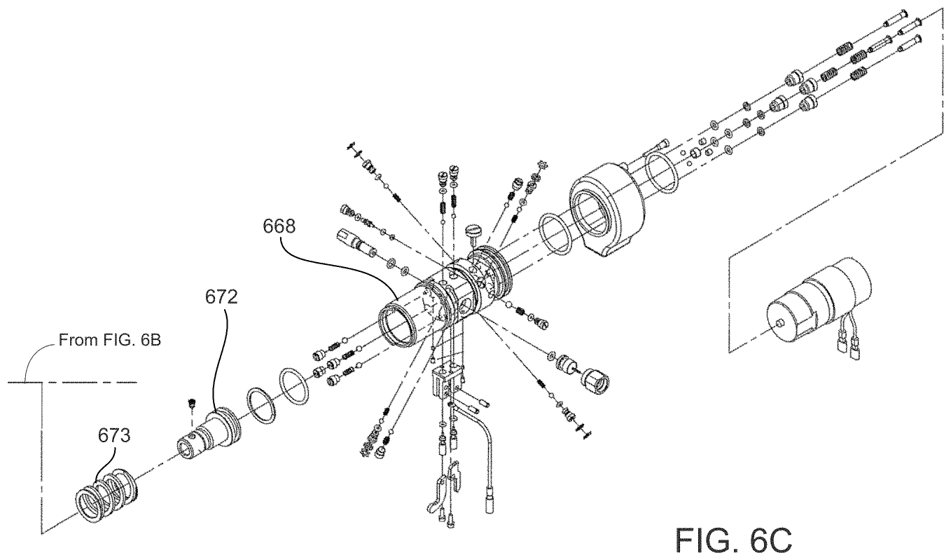

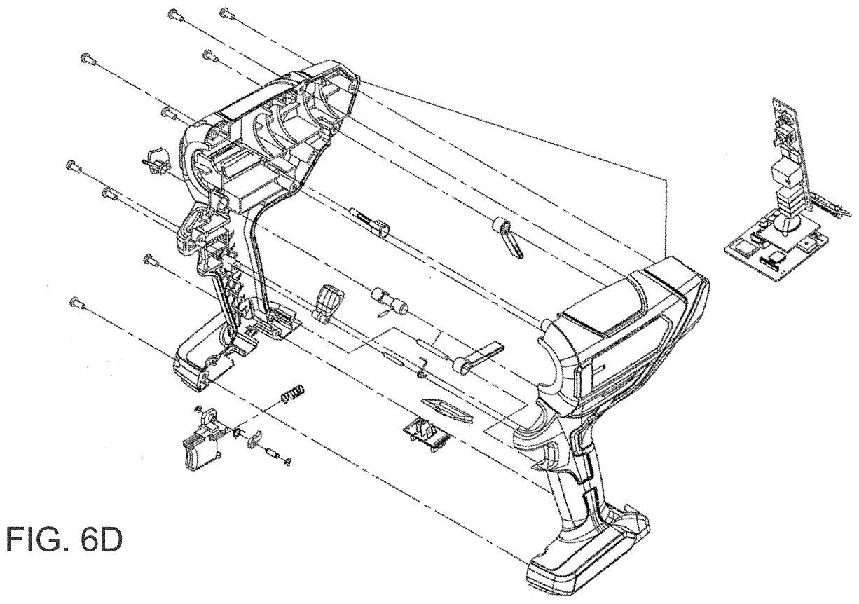

Referring now to FIGS. 6A, 6B, 6C, and 6D, a compression tool according to embodiments of the invention is shown. According to the embodiment, the body 668, ram 672, body head 675, die holder 685, yoke 690, and latch 693 may be designed and made from advanced materials with high specific strength, such as carbon fiber composite material, thermoplastic or thermoset polymer materials or resin systems reinforced with continuous carbon fiber, chopped fiber or glass fiber, or titanium. Alternatively, they may be of a metal composite construction, so to provide surfaces with the strength and hardness properties of tool steel supported with the strength and weight properties of high performance polymers.

Still referring to FIGS. 6A, 6B, 6C, and 6D, the spring 673, and slide pin 679 may be designed and made from titanium or a titanium alloy. Likewise, components may be constructed using additive manufacturing techniques such as 3D printing or the like. Such additive manufacturing techniques may be combined with one or more conventional techniques such as molding, or bonding, which may include lamination of metal and composite material with epoxy, or other conventional processes.

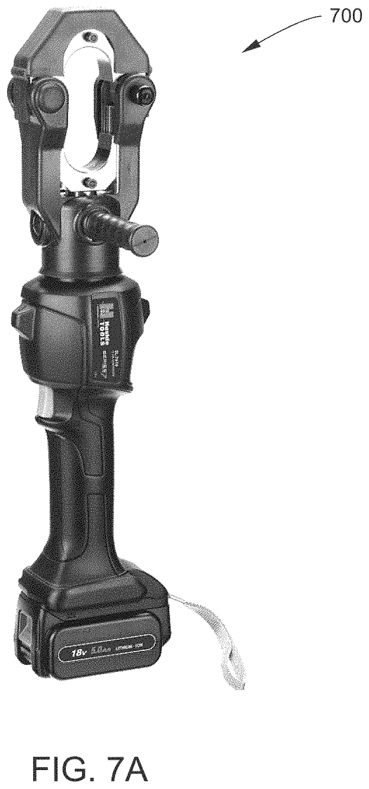

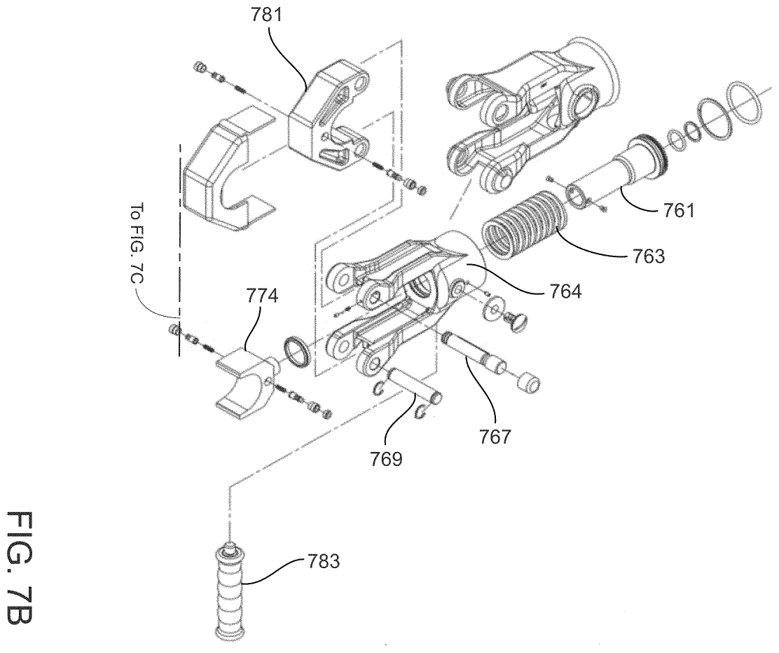

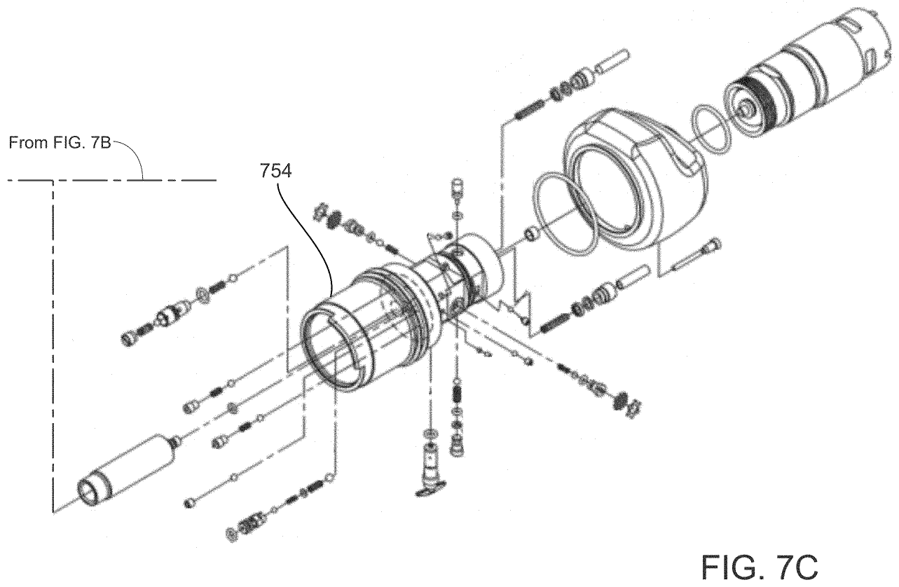

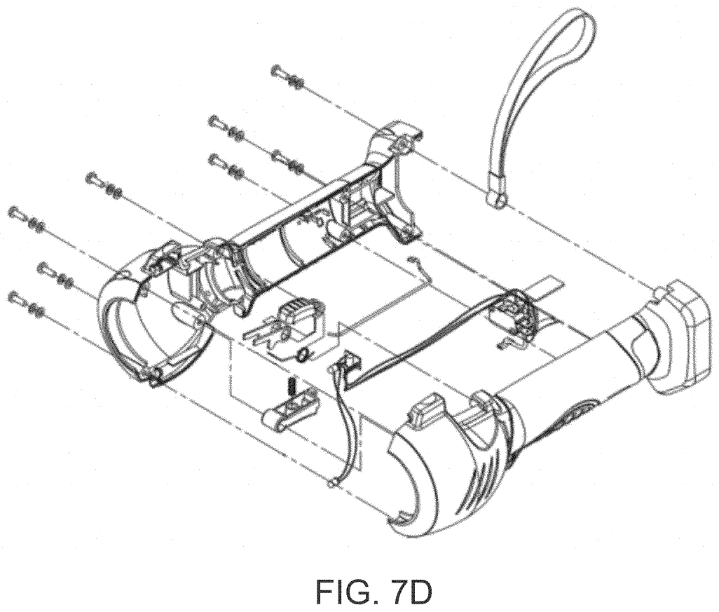

Referring to FIGS. 7A, 7B, 7C, 7D, a compression tool according to the present invention is shown according to embodiments of the invention. According to this embodiment, the body 754, ram 761, cylinder head 764, tool jaw 774, yoke 781, and grip 783 may be designed and made from advanced materials with high specific strength, such as carbon fiber composite material, thermoplastic or thermoset polymer materials or resin systems reinforced with continuous carbon fiber, chopped fiber or glass fiber, or titanium. Alternatively, they may be of a metal composite construction, so to provide surfaces with the strength and hardness properties of tool steel supported with the strength and weight properties of high performance polymers.

Referring to FIGS. 7A, 7B, 7C, 7D, the spring 763, lock pin 767, and pin 769 may be designed and made from titanium or a titanium alloy. According to such an embodiment, components may be constructed using additive manufacturing techniques such as 3D printing or the like. Such additive manufacturing techniques may be combined with one or more conventional techniques such as molding, or bonding, which may include lamination of metal and composite material with epoxy, or other conventional processes.

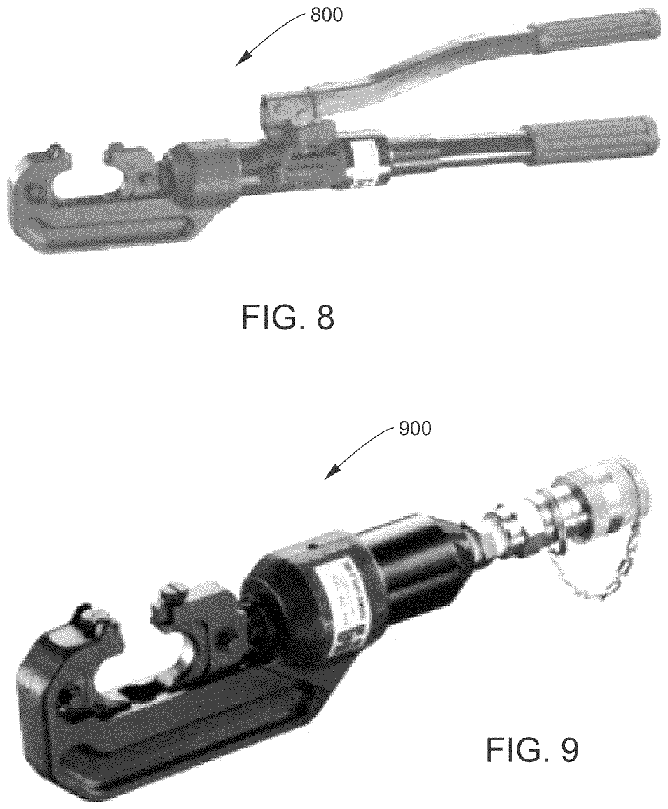

Referring to FIG. 8, an alternative embodiment 800 is shown where the power for the hydraulic movement is supplied via manual operation.

Referring to FIG. 9, an alternative embodiment 900 is shown where the power for the hydraulic movement is remotely supplied, such as via a compressor (not shown) connected via a hose.

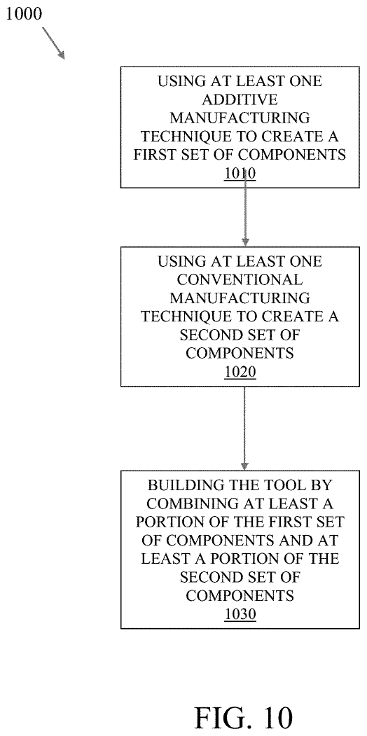

Referring to FIG. 10, a method 1000 for manufacturing a battery powered hydraulic cutting or compression tool is illustrated. The first step, as represented by block 1010, is using at least one additive manufacturing technique to create a first set of components. The additive manufacturing technique may be or include 3D printing or the like. The next step, as represented by block 1020, is using at least one conventional manufacturing technique to create a second set of components. The conventional manufacturing technique may be or include molding, or bonding, which may include lamination of metal and composite material with epoxy, or other conventional processes. The last step, as represented by block 1030, is building the tool by combining at least a portion of the first set of components and at least a portion of the second set of components. The building may be based on the exploded views of the various embodiments of tools as illustrated in the various figures and discussed herein.

The foregoing has described battery operated hydraulic cutting and compression tools using lightweight alternative components. While specific embodiments of the present invention have been described, it will be apparent to those skilled in the art that various modifications thereto can be made without departing from the spirit and scope of the invention. Accordingly, the foregoing description of the preferred embodiment of the invention and the best mode for practicing the invention are provided for the purpose of illustration only and not for the purpose of limitation.

What is claimed is:

1. A battery powered hydraulic cutting tool comprising:
a cutting assembly made from a material with high specific strength;
a ram assembly made from titanium; and
wherein the cutting tool is at least partially constructed using one or more additive manufacturing techniques.

2. The battery powered hydraulic cutting tool of claim 1 wherein the cutting assembly comprises a body head, a blade, a latch, a main head, a spacer, a head sheer, a ram, and a body.

3. The battery powered hydraulic cutting tool of claim 1 wherein the material with high specific strength is one or more of: carbon fiber composite material, thermoplastic or thermoset polymer materials or resin systems reinforced with continuous carbon fiber, chopped fiber or glass fiber, or titanium.

4. The battery powered hydraulic cutting tool of claim 3 wherein the material with high specific strength further comprises a metal composite for providing surfaces with the strength and the hardness properties of a tool steel supported with the strength and weight properties of high performance polymers.

5. The battery powered hydraulic cutting tool of claim 1 wherein the ram assembly comprises a pin, a bolt, a spring, a washer, a nut, and a blade screw.

6. The battery powered hydraulic cutting tool of claim 1 wherein the additive manufacturing techniques include 3D printing.

7. The battery powered hydraulic cutting tool of claim 1 wherein the cutting assembly comprises a body, a ram, a body head, a support plate, a link, a link head, a collar, a blade assembly, and a blade.

8. The battery powered hydraulic cutting tool of claim 7 wherein the material with high specific strength is one or more of: carbon fiber composite material, thermoplastic or thermoset polymer materials or resin systems reinforced with continuous carbon fiber, chopped fiber or glass fiber, or titanium.

9. The battery powered hydraulic cutting tool of claim 1 wherein the cutting assembly comprises a body, a ram, a body head, a support plate, a link, a link head, a collar, a blade assembly, and a blade.

10. The battery powered hydraulic cutting tool of claim 9 wherein the material with high specific strength is one or more of: carbon fiber composite material, thermoplastic or thermoset polymer materials or resin systems reinforced with continuous carbon fiber, chopped fiber or glass fiber, or titanium.

11. The battery powered hydraulic cutting tool of claim 1 wherein the ram assembly comprises a spring, a shoulder bolt, a pin, and a stud bolt.

12. A battery powered hydraulic compression tool comprising
a ram assembly made from a material with high specific strength; and
a spring assembly made from titanium;
wherein the compression tool is constructed at least partially using one or more additive manufacturing techniques.

13. The battery powered hydraulic compression tool of claim 12 wherein the ram assembly comprises: a head, a body, a ram, a ram head, spring, and a guide ring.

14. The battery powered hydraulic compression tool of claim 12 wherein the material with high specific strength is one or more of: carbon fiber composite material, thermoplastic or thermoset polymer materials or resin systems reinforced with continuous carbon fiber, chopped fiber or glass fiber, or titanium.

15. The battery powered hydraulic compression tool of claim 14 wherein the material with high specific strength further includes a metal composite for providing surfaces with the strength and the hardness properties of a tool steel supported with the strength and weight properties of high performance polymers.

16. The battery powered hydraulic compression tool of claim 12 wherein the ram assembly comprises a spring.

17. The battery powered hydraulic compression tool of claim 12 wherein the additive manufacturing techniques include 3D printing.

18. The battery powered hydraulic compression tool of claim 12 wherein the ram assembly comprises: a body, a ram, a body head, a die holder, a yoke, and a latch.

19. The battery powered hydraulic compression tool of claim 12 wherein the ram assembly comprises a spring and a slide pin.

20. The battery powered hydraulic compression tool of claim 12 wherein the ram assembly comprises: a body, a ram, a cylinder head, a tool jaw, a yoke, and a grip.

21. The battery powered hydraulic compression tool of claim 12 wherein the ram assembly comprises: a spring, a lock pin, and a pin.

22. A method for manufacturing a battery powered hydraulic cutting or compression tool, the method comprising:
using at least one additive manufacturing technique to create a first set of components;
using at least one conventional manufacturing technique to create a second set of components; and
building the tool by combining at least a portion of the first set of components and at least a portion of the second set of components.
